(19) United States
(12) Patent Application Publication
(10) Pub. No.: US 2010/0167244 A1
(43) Pub. Date: Jul. 1, 2010

(54) LANGUAGE TEACHING SYSTEM OF ORIENTATION PHONETIC SYMBOLS

(76) Inventor: WEI-CHOU SU, Tainan City (TW)

Correspondence Address: WEI-CHOU SU, 235 Chung-Ho Box 8-24, Taipei, 235, TW

(21) Appl. No.: 12/703,781

(22) Filed: Feb. 11, 2010

Related U.S. Application Data
(63) Continuation-in-part of application No. 11/650,598, filed on Jan. 8, 2007, now abandoned.

(51) Int. Cl. G09B 19/06; G09B 5/00; G09B 1/00

(52) U.S. Cl. 434/157; 434/169; 434/172

(57) ABSTRACT

A language teaching system of orientation phonetic symbols includes a pronunciation teaching module containing a word bank unit and an identification-conversion unit. The word bank unit includes large Chinese vocabulary, English single word data, and Chinese and English phonetic symbol word data. The arrangement of each English letter marked to English orientation phonetic symbol word is the same as a specified English single word, and the arrangement of each English letter marked to Chinese orientation phonetic symbol word is the same as the Chinese phonetic symbols of a specified Chinese character. A specified letter of the English phonetic symbol word is marked with a pronunciation auxiliary mark at its periphery to represent its sound. The identification-conversion unit collates the Chinese orientation phonetic symbol word and displays it on a screen.

The present invention is a continuation in part (CIP) of U.S. patent Ser. No. 11/650,598 which is assigned to and disclosed by the inventor of the present invention. Thus the contents of the U.S. patent Ser. No. 11/650,598 is incorporated into the present invention as a part of the invention.

### BACKGROUND OF THE INVENTION

1. Field of the Invention

This invention relates to a language teaching system of orientation phonetic symbols, particularly to one by which English and Chinese language can be learned interchangeably.

2. Description of the Prior Art

It is undeniable that speaking English with correct pronunciation is no easy work. At present, English teachers all over the world assist their students to pronounce a single English word by means of K.K. phonetic symbols of twenty-six letters in English alphabet and by ways of natural pronunciation. However, although understanding the meaning of an English word, most students are unable to pronounce the word correctly and hence dare not speak out the word directly because they cannot definitely identify the difference of pronunciation of a same letter in different English words. For example, the letter “a” in a single English word can be pronounced as “e”, “a”, “ε”, “ae”, “ [symbol] ”, “i” or “ [symbol] ”, and these varied phonetic symbols really puzzle English learners.

Different from English, the pronunciation of Chinese vocabulary is definitely composed of thirty-seven phonetic symbols and five marks of pronunciation intonations. By means of the interchanging English alphabets and the Chinese phonetic symbols, the inventor of this invention researched and developed a bearing phonetic symbols and language teaching system for facilitating learning of both English and Chinese language.

### SUMMARY OF THE INVENTION

A first objective of this invention is to offer a language teaching system of orientation phonetic symbols for helping people to learn English pronunciation.

A second objective of this invention is to offer a language teaching system of orientation phonetic symbols, helpful to learn Chinese pronunciation.

The language teaching system of orientation phonetic symbols in the present invention is possible to be built in an electronic computer that is formed with a screen. The language teaching system of orientation phonetic symbols includes a pronunciation teaching module consisting of a word bank unit and an identification-conversion unit. The word bank unit is built therein with lots of English single word data and English phonetic symbol word data. Arrangement of English letters of each English phonetic symbol word is completely the same as that of a definite English single word, and a pronunciation auxiliary mark representing the sound of the English letters is marked at a designated location on the periphery of the English phonetic symbol word. According to the sound of an English letter, the pronunciation auxiliary mark marked on the English letter, which serves as a vowel, of the English phonetic symbol word is correspondingly marked at one of the following spots of the English letter: a central one, an exactly upper one, an exactly lower one, a left side one, a right side one, an upper left one, a lower left one, an upper right one and a lower right one. After a word input device is input therein with English letters, the identification-conversion unit can collate and display an English phonetic symbol word of the English single word from the word bank unit so as to enable a user to select the form of a letter he needs and display it on the screen.

The language teaching system of orientation phonetic symbols of this invention is possible to be built in an electronic computer formed with to a screen. The orientation phonetic symbols and language teaching system consists of a pronunciation teaching module that contains a word bank unit and an identification-conversion unit. The word bank unit is built therein with many Chinese vocabulary data and lots of Chinese phonetic symbol words respectively corresponding with their Chinese vocabulary. The arrangement of the English letters representing each Chinese phonetic symbol completely corresponds to that of the Chinese phonetic symbols of the Chinese vocabulary, including one to several English letters arranged from the left to the right. The first English letter at the left side is a capital letter, and a numeral standing for a Chinese intonation is located at the right side of the last English letter, and the pronunciation auxiliary mark marked on the English letter, which serves as a vowel, of the Chinese phonetic symbol word is correspondingly marked at one of the following spots of the English letter: a central one, an exactly upper one, an exactly lower one, a left side one, a right side one, an upper left one a lower left one, an upper right one and a lower right one. After the word input device is input with English letters, the identification-conversion unit can collate and display the Chinese vocabulary and a Chinese phonetic symbol from the word bank unit to enable a user to select the word he requires and display it on the screen.

The effect of this invention is that the language teaching system of orientation phonetic symbols invented by the inventor through newly designed orientation vowel phonetic symbols and orientation consonant phonetic symbols can not only help Chinese people to learn English pronunciation but also enable foreigners to learn Chinese, having great practicability.

### BRIEF DESCRIPTION OF DRAWINGS

This invention will be better understood by referring to the accompanying drawings, wherein:

FIG. 1 is a block diagram of the function of a language teaching system of orientation phonetic symbols in the present invention;

FIG. 2 is a schematic view in the present invention, illustrating a screen displaying plural English single words respectively marked with a pronunciation auxiliary mark after inputting characters;

FIG. 3 is a schematic view in the present invention, illustrating a screen displaying plural Chinese words respectively marked with a pronunciation auxiliary mark after inputting characters;

FIG. 4 is a schematic view of a phonetic symbol table of the sounds of nine vowels of a letter displayed on a screen, which are respectively located at the periphery and the center of the letter in nine orientation blocks and guided to pronounce by means of K.K. phonetic symbols and their corresponding Chinese phonetic symbols;

FIG. 5 is a schematic view illustrating a screen displaying English consonants and English phonetic symbol letters respectively marked with pronunciation auxiliary marks, which are then guided pronounce by means of K.K. phonetic symbols and corresponding Chinese phonetic symbols;

FIG. 6 is a schematic view of a Chinese and English intonation table displayed on the screen in the present invention;

FIG. 7 is a schematic view in the present invention, illustrating that an auxiliary viewing window appears on the screen when a single letter of an English word marked with an orientation phonetic symbol word is pinpointed and selected;

FIG. 8 is a schematic view in the present invention, illustrating that an auxiliary viewing window appears on the screen when the letters of an English word, which are marked with orientation phonetic symbol, are totally pinpointed and selected;

FIG. 9 is a schematic view similar to FIG. 8 in the present invention, illustrating the contents displayed in the auxiliary viewing window when an English single word is pinpointed and selected; and

FIG. 10 is a schematic view similar to FIG. 9 in the present invention, illustrating the contents displayed in the auxiliary viewing window when a Chinese vocabulary is pinpointed and selected.

### DETAILED DESCRIPTION OF THE PREFERRED EMBODIMENT

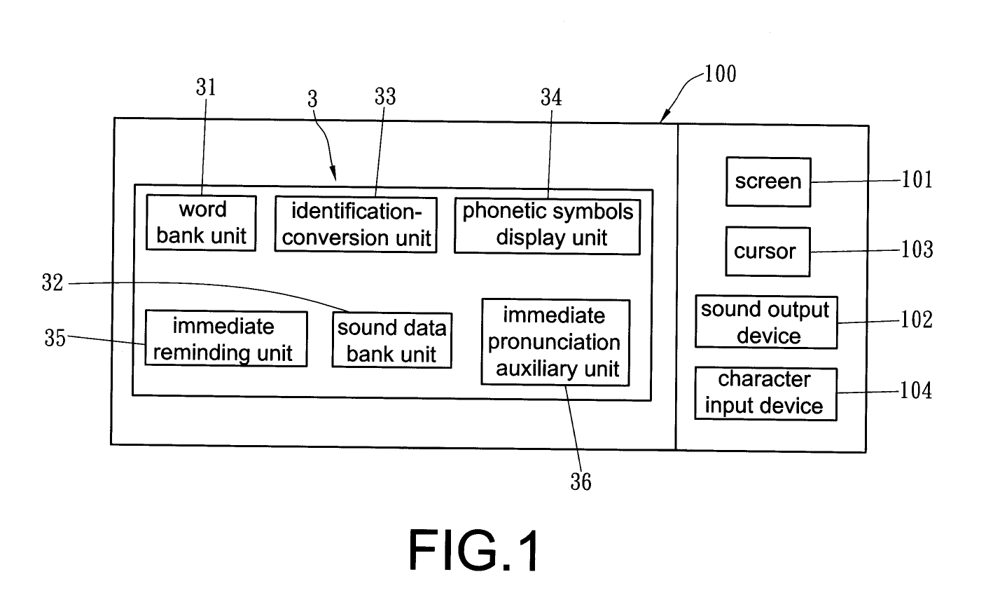

A preferred embodiment of a language teaching system of orientation phonetic symbols in the present invention, as shown in FIGS. 1, 2 and 3, is possible to be built and carried in an electronic computer 100. The electronic computer 100 has a screen 101 employed for displaying images and a sound output device 102 for outputting sounds, a cursor 103 displayed on the screen 101 for pinpointing and selecting data and a character input device 104 for inputting English alphabets.

The language teaching system of orientation phonetic symbols in the present invention includes a pronunciation teaching module 3, which consists of a word bank unit 31, a sound data bank unit 32, an identification-conversion unit 33, a phonetic symbols display unit 34, an immediate reminding unit 35 and an immediate pronunciation auxiliary unit 36.

The word bank unit 31 is built therein with many English words, many English phonetic symbol words 311 respectively corresponding with the English words, many Chinese words, many Chinese phonetic symbol words 313 respectively corresponding with the Chinese words, many pronunciation auxiliary marks 312 respectively corresponding with the English phonetic symbol words 311, many pronunciation auxiliary marks 312 respectively corresponding with the Chinese phonetic symbol words 313 and further many sound data added to the pronunciation auxiliary marks 312 and marked with conventional Chinese phonetic symbols and K.K. phonetic symbols.

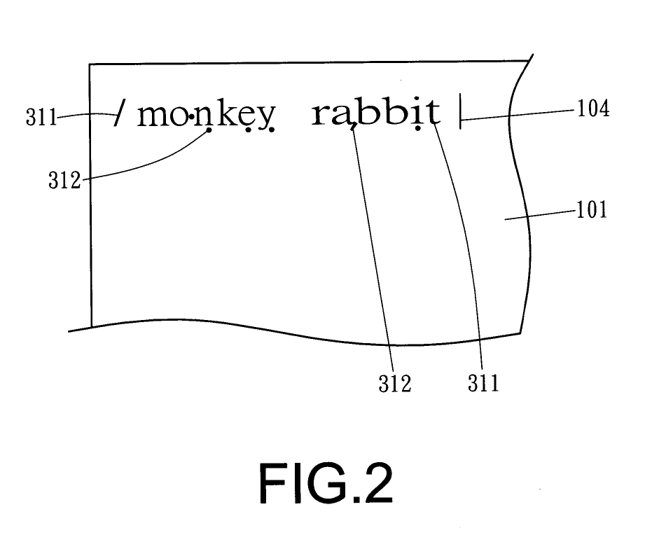

After English letters are input in the character input device 104, the English letters will be collated by the word bank unit 31 and their English phonetic symbol words 311 will be displayed on the screen 101 of the electronic computer 100, as shown in FIG. 2, and the arrangement of the letters of the English phonetic symbol words 311 is completely the same as that of the input English word. The specified English letter 348 of the English phonetic symbol words 311 are respectively marked with a pronunciation auxiliary mark 312 at a predetermined location on its periphery for representing the sound of the specified English letters.

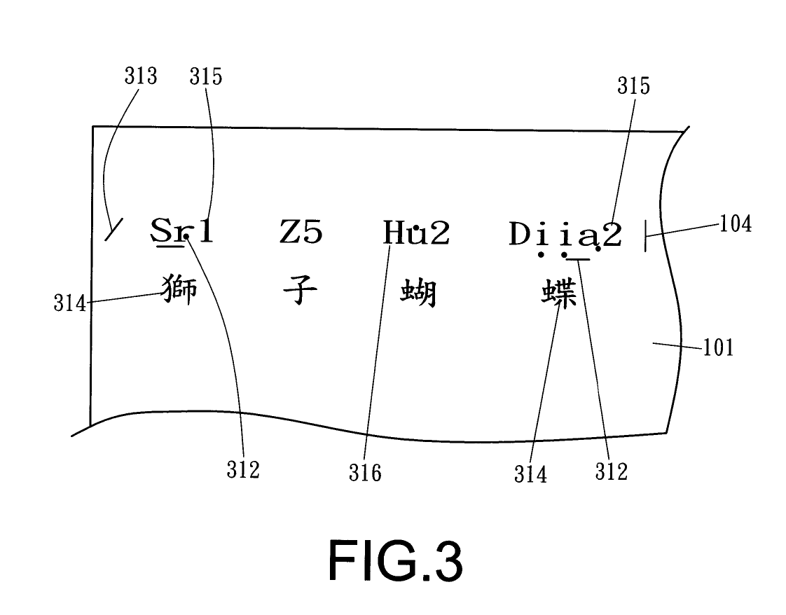

After an English letter is input in the character input device 104 and collated by the word bank unit 31, the Chinese phonetic symbols 313 and the Chinese vocabulary 314 will be displayed on the screen 101, as shown in FIG. 3, and the arrangement of the English letters of each Chinese phonetic symbol word is completely corresponding to the phonetic symbol of the Chinese vocabulary, including one to several English letters arranged from the left to the right. The first English letter at the left side is a capital letter 316, and a numeral 315 representing a Chinese intonation is located at the right side of the last English letter. Further, the specified English letter 348 tantamount to the Chinese phonetic symbol word 313 is respectively marked with a pronunciation auxiliary mark 312 at a predetermined location on the periphery for representing the sound of the English word.

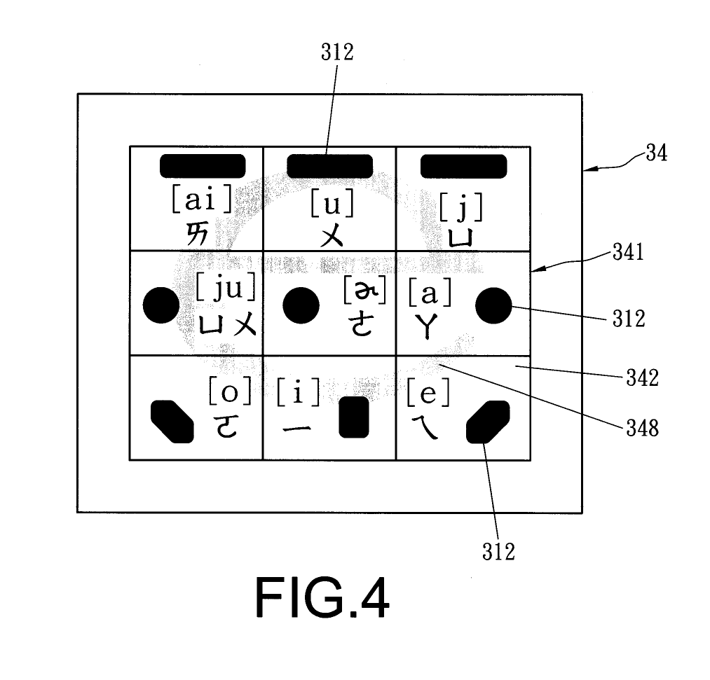

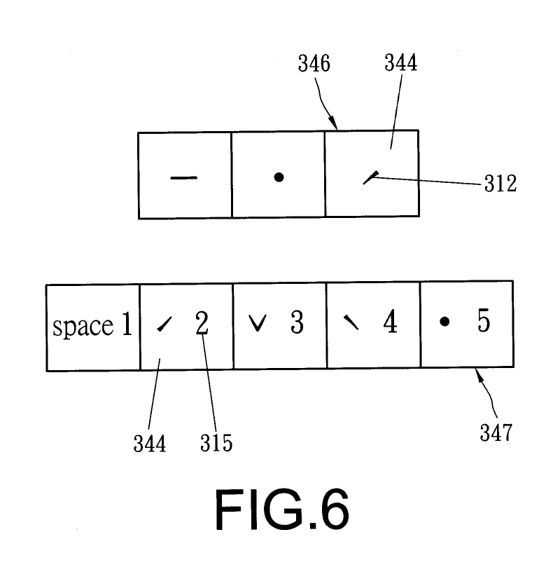

In this preferred embodiment, the pronunciation auxiliary mark 312 (“•”, “-”, “/”) of the English phonetic word 311 and the Chinese phonetic symbol word 313 is marked at the periphery and the central portion of the English letter 348. As shown in FIG. 4, the English vowels are arranged and delimited into nine orientation blocks arranged in matrixes, and the nine orientation blocks for the English vowels are laid from the left to the right and from the above to the below, namely an upper left side one, an upper intermediate one, an upper right side one, a left intermediate one, a central one, a right intermediate one, a lower left side one, a lower intermediate one and a lower right side one. The pronunciation auxiliary marks 312 are written in one of the orientation blocks in accordance with the sound of the English vowel, and there are three kinds of the pronunciation auxiliary marks 312 put on the English letter, as shown in FIG. 6, one being a dot

[symbol]

representing a short sound, another one is a dash “-” representing a long sound, and the third one is a slanting stroke “/” representing an accent pronounced with force. Pertaining to the locations of the pronunciation auxiliary marks 312 and their corresponding sounds will be described subsequently.

The whole pronunciation data is composed of many Chinese phonetic symbols and K.K. phonetic symbols arranged from the left to the right and respectively able to be employed for pronouncing the English phonetic symbol word 311, and the sound data are composed of Chinese phonetic symbols and K.K. phonetic symbols, which are similar or the same in pronunciation.

The sound data bank unit 32 is built therein with many sound data regarding the pronunciation of the English phonetic symbol words 311, many sound data regarding the pronunciation of the Chinese vocabulary of the Chinese phonetic symbol words 313 and many sound data pertaining to the pronunciation of the English letters marked with the pronunciation auxiliary marks 312.

From the word bank unit 31, the identification-conversion unit 33 can collate and identify the corresponding English phonetic symbol words 311 and the corresponding Chinese phonetic symbol words 313 of the English letters and the Chinese vocabulary 314 displayed on the screen 101, and the Chinese vocabulary 314, enabling a user to select the form of characters he needs and display it on the screen.

Referring to FIGS. 1, 4˜6, the phonetic symbol display unit 34 can be operated by the electronic computer 100, and the screen 101 can display a vowel orientation phonetic symbol table 341, a consonant orientation phonetic symbol table 343, an English pronunciation-intonation table 346 and a Chinese pronunciation-intonation table 347.

The vowel orientation phonetic symbol table 341 shown in FIG. 4 is formed with nine matrix-arranged orientation blocks 342 corresponding with the nine orientation blocks of foresaid English letter 348 marked with the pronunciation auxiliary marks. Each orientation block 342 of the vowel orientation phonetic symbol table 341 is respectively defined to represent a sound of a specific English vowel and is respectively marked with a sound symbol standing for the sound of the vowel. In this preferred embodiment, the sound symbol marked in each orientation block 342 is composed of a Chinese phonetic symbol and a K.K. phonetic symbol, which are the same or similar in pronunciation. Therefore, in the English phonetic symbol words 311 shown in FIG. 2 and the Chinese phonetic symbol words 313 shown in FIG. 3, built in the word bank unit 31, the pronunciation auxiliary marks 312 of the English letter that represents a vowel will be marked according to the sound of the vowel and contrasting the location of the vowel sound of the vowel orientation phonetic symbol table 341. For instance, referring to FIG. 2, in the English word “monkey”, when the letter “o” is pronounced as “Λ”, the pronunciation auxiliary mark 312 is a round dot “•”marked at a right side of the letter “O” to form a mark “O•”.

The English pronunciation intonation table 346 shown in FIG. 6 is formed with several matrix-arranged square blocks 344 respectively marked therein with a symbol representing a specific intonation. In this preferred embodiment, the intonations are those of English pronunciation. For instance, referring to FIG. 6, when the letter is pronounced as “e”, “ε” or “ae”, the pronunciation auxiliary marks 312 will be respectively a dash “-”, a dot “•” or a slanting stroke “/” marked at a specified lower right side of the letter.

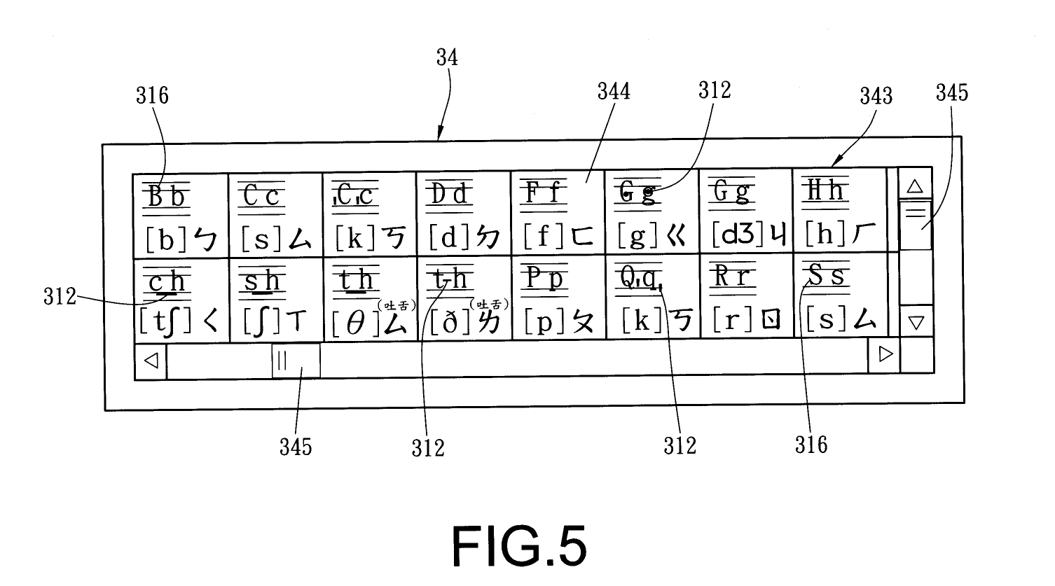

The consonant orientation phonetic symbol table 343 shown in FIG. 5 is formed with several matrix-arranged square blocks 344 and an adjusting key 345 for adjusting and changing the square blocks 344 appearing in the consonant orientation phonetic symbol table 343 to move up and down, and also left and right. Each square block 344 is marked therein with English letters used to serve as the capital or the lower case of a consonant, or marked with English letters used to serve as the capital or the lower case of consonants that are marked with the pronunciation auxiliary marks 312, or marked with two different English letters arranged at the left and the right side and having a pronunciation auxiliary mark 312 placed under or between the two English letters. For example, a line extends across the lower side of the two English letters, or lies between the two letters. In addition, the lower side of the capital and the lower case of English letters, or the lower side of the two side-by-side arranged English letters are respectively marked with a pronunciation symbol for representing the English letter or representing the consonant sound of the English letter. In this preferred embodiment, the sound symbols are composed of K.K. phonetic symbols and Chinese phonetic symbols, which are similar or the same in pronunciation.

The Chinese pronunciation intonation table 347 shown in FIG. 6 is formed with several matrix-arranged square blocks 344 respectively marked with a symbol standing for specified intonation and a numeral corresponding with the intonation. In this preferred embodiment, the intonations are Chinese pronunciation ones, which are classified into a first one (a level tone, symbol: no but by striking space key), a second one (a rising tone, symbol: [symbol] ,

a third one (a falling-rising one, symbol: “ν”, a fourth one (a falling intonation, symbol: [symbol] ,
and a neutral one (a soft intonation, symbol: “•”. The Chinese intonation numerals 315 representing the level one, the rising one, the falling-rising one, the falling one and neutral one are “1 or space”, “2”, “3”, “4” and “5” respectively.

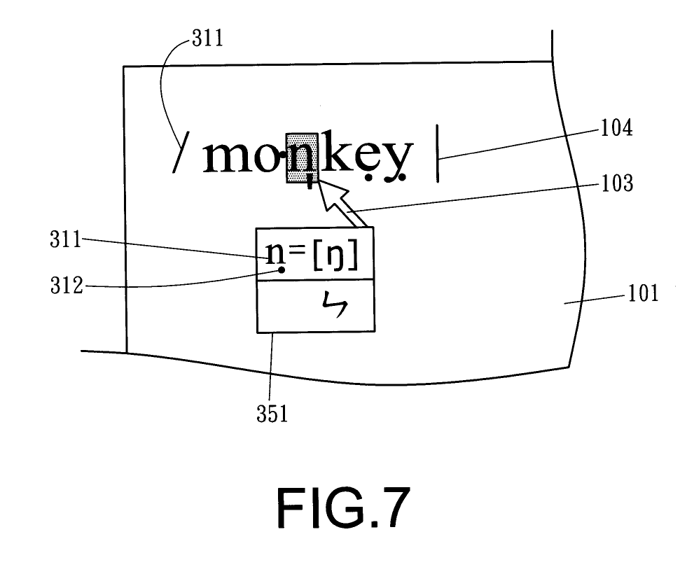

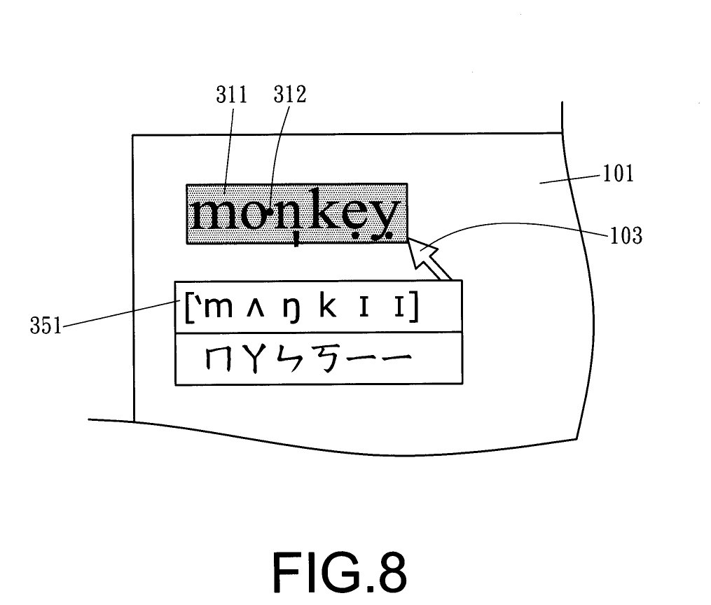

Referring to FIGS. 1, 7 and 8, when the immediate reminding unit 35 is operated by the electronic computer 100 and when the electronic computer 100 moves the cursor 103 on the screen 101 to pinpoint and select a complete English phonetic symbol word 311, or a single English phonetic symbol word 311 and a Chinese phonetic symbol word 313 in which the English letter is marked with the pronunciation auxiliary marks 312, an auxiliary viewing window 351 will immediately appear at the location of the English phonetic symbol word or the English letter on the screen 101 according to the complete pronunciation data and sound data built in the word bank unit 31. In the auxiliary viewing window 351, the complete pronunciation data corresponding with the English phonetic symbol word 311, or the sound data corresponding with the English letter will be displayed to let a user observe and understand how to read the Chinese and the English phonetic symbol words or the Chinese and the English words.

In this preferred embodiment, the immediate reminding unit 35 is designed to have the auxiliary viewing window 351 displayed immediately when the English phonetic symbol word or the English letter to be pinpointed and selected by the cursor 103 becomes reverse video, but the immediate reminding unit 35 can display the auxiliary viewing window 351 in other modes.

When the immediate pronunciation auxiliary unit 36 is operated by the electronic computer 100 and when an English phonetic symbol word 311, a Chinese phonetic symbol word 313 or an English letter marked with a pronunciation auxiliary mark 312 is pinpointed and is selected by the cursor, the sound data bank unit 32 will collate and pick out the sound data corresponding with the selected English phonetic symbol word 311, the Chinese phonetic symbol word 313 or the English letter and transmit the sound data to the sound output device 102 to be amplified and output so that a user can hear the sounds.

In use of the language teaching system of orientation phonetic symbols, when Chinese characters, English characters, or an article mixed with Chinese and English words displayed on the screen 101 are input in the word input device 104 by means of the electronic computer 100, if a user is unable to understand the pronunciation of the Chinese or English words in the article, all the Chinese and English words can be converted into Chinese phonetic symbol words 313, English phonetic symbol words 311 and pronunciation auxiliary marks 312 to enable the user to know how to read the words by using the pronunciation teaching module 3. In addition, by handling the phonetic symbol display unit 34, the vowel orientation phonetic symbol table 341 and the consonant orientation phonetic symbol table 343 can be displayed on the screen 101, convenient to contrast the pronunciation auxiliary marks 312 marked on the English phonetic symbol words 311.

Moreover, when the cursor 103 is employed to pinpoint and select specified English phonetic symbol words 311 or enquire the English letters marked with pronunciation auxiliary marks 312 by operating the immediate reminding unit 35, the complete pronunciation data of the English phonetic symbol word 311 or the sound data of the English letter will be displayed at once. When a user wants to know the correct pronunciation of a certain English phonetic symbol word 311 or an English letter marked with a pronunciation auxiliary mark 312, simply operate the immediate pronunciation auxiliary unit 36 and the pronunciation of the English phonetic symbol words 311 or the English letters selected by the cursor 103 will be sounded out immediately for the user to listen to and imitate.

When a user, such as a foreigner, does not know the pronunciation of the Chinese vocabulary 314 displayed on the screen 101, the Chinese vocabulary 314 can be converted into Chinese phonetic symbol word 313 and displayed on the screen 101 by means of the identification-conversion unit 33. Thus, the user can read out the pronunciation of the Chinese vocabulary 314 through the English letter marked with the pronunciation auxiliary mark 312 and the numeral. If necessary, the phonetic symbol display unit 34 can also be used to have the vowel orientation phonetic symbol table 341, the consonant orientation phonetic symbol table 343, the English pronunciation tone table 346 and the Chinese pronunciation tone table 347 displayed on the screen 101 for facilitating contrast. Of course, through the immediate pronunciation auxiliary unit 36, the pronunciation of the selected Chinese phonetic symbol word 313 can also be output immediately for a user to listen to and imitate.

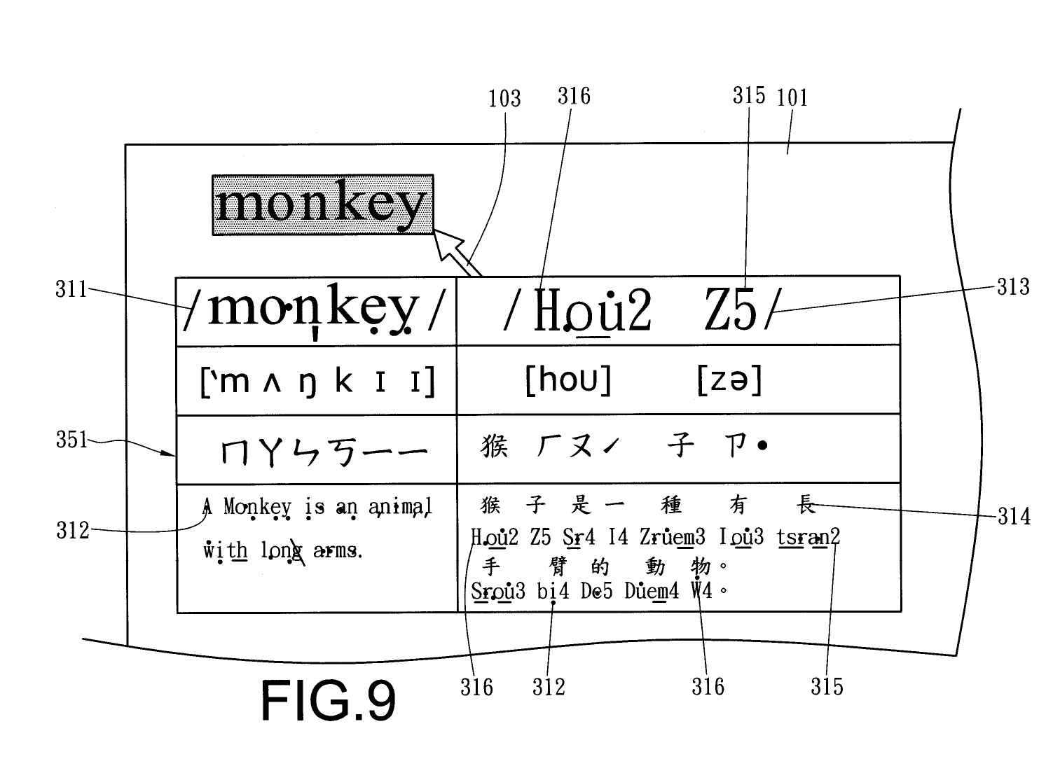

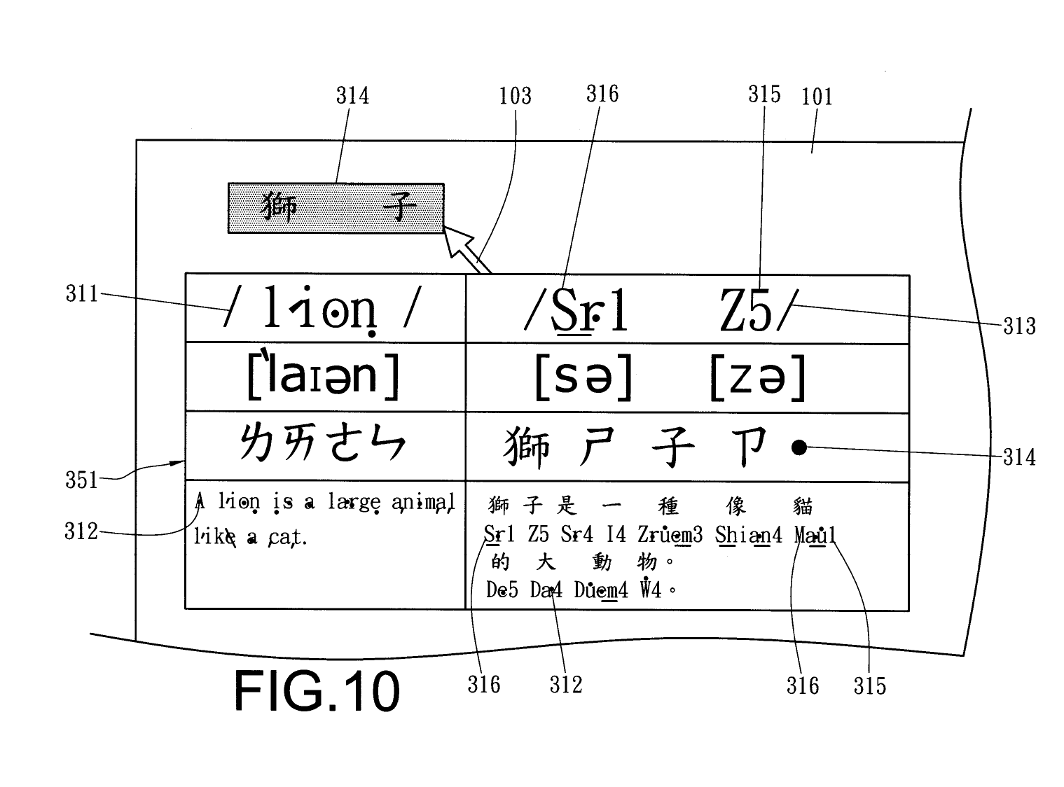

Referring to FIGS. 9 and 10, when this invention is put into effect and when a complete English phonetic symbol word 11 is pinpointed and selected by the cursor 103, the immediate reminding unit 5 will have the auxiliary viewing window 351 not only to display the complete pronunciation data of the English phonetic symbol word 311 in the auxiliary viewing window 351 but also display a corresponding Chinese phonetic symbol word 313, an English sentence composed of the English phonetic symbol word 311 and other English phonetic symbol words 311 and Chinese vocabularies translated from the English sentence and consisting of its Chinese phonetic symbol words 313. When a Chinese word or a Chinese phonetic symbol word is pinpointed and selected by the cursor 103, the auxiliary viewing window 351 will not only display the Chinese phonetic symbol word 313 and its corresponding English phonetic symbol word 311 constituted of K.K. phonetic symbols and Chinese phonetic symbols, but will also display a sentence made of Chinese vocabulary 314 and a sentence made of Chinese phonetic symbol words 313 of the Chinese vocabulary 314 and a sentence corresponding with the English phonetic symbol words translated from the Chinese sentence into English. Nevertheless, the function of the immediate reminding unit 35 can be designed beyond what is mentioned above.

To sum up, with the pronunciation teaching module 3 designed by the inventor of this invention, the language teaching system of orientation phonetic symbols in the present invention not only helps Chinese people to learn English pronunciation but also enable foreigners to learn Chinese language with convenience, having great practicability.

While the preferred embodiment of the invention has been described above, it will be recognized and understood that various modifications may be made therein and the appended claims are intended to cover all such modifications that may fall within the spirit and scope of the invention.

What is claimed is:

1. A language teaching system of orientation phonetic symbols possible to be built in an electronic computer formed with a screen, said orientation phonetic symbol and language teaching system provided with a pronunciation teaching module, said pronunciation teaching module comprising:
a word bank unit built therein with many English single word data and many English phonetic symbol word data, English letters of each said English phonetic symbol word completely the same as a specified English single word in arrangement, a pronunciation auxiliary mark representing pronunciation of said English letter respectively marked at a specified location of a periphery of said English phonetic symbol word, in said English phonetic symbol word said pronunciation auxiliary mark on English letters serving as vowels, being correspondingly marked at a central spot, an exactly upper spot, an exactly lower spot, a left side spot, a right side spot, an upper left spot, a lower left spot, an upper right spot and a lower right spot of said English letter according to the sound of said English letter; and
a character input device, after letters are input in said character input device, an identification-conversion unit able to collate and pick out English phonetic symbol word of said English single word from said word bank unit to enable a user to select a needed character and display it on a screen.

2. A language teaching system of orientation phonetic symbols as claimed in claim 1, wherein said pronunciation module also comprises a phonetic symbol display unit, said phonetic symbol display unit able to display a vowel orientation phonetic symbol table on a screen, said vowel orientation phonetic symbol table formed with nine matrix-arranged orientation blocks respectively defined to show a specific vowel.

3. A language teaching system of orientation phonetic symbols as claimed in claim 2, wherein said phonetic symbol display unit can also display a consonant orientation phonetic symbol table formed with several matrix-arranged square blocks, said square blocks respectively showing at least one English letter serving as a consonant, or an English letter serving as a consonant and marked with a definite pronunciation auxiliary mark at a predetermined location, a sound symbol representing a sound of consonant of said English letter respectively marked at a location adjacent to each English letter.

4. A language teaching system of orientation phonetic symbols as claimed in claim 1, wherein said electric computer is provided with a cursor able to move on a screen, pinpoint and select letters displayed on the screen, said word bank unit also built therein with many complete pronunciation data respectively corresponding with a specified English phonetic symbol word, and many sound data respectively corresponding with a specified English letter marked with a pronunciation auxiliary mark, said pronunciation teaching module also comprising an immediate reminding unit, said immediate reminding unit able to collate and select corresponding complete pronunciation data or sound data from said word bank unit and display on the screen an auxiliary viewing window with said complete pronunciation data or with said sound data when said cursor is pinpointed to select an English phonetic symbol word or one English letter in an English phonetic symbol word.

5. A language teaching system of orientation phonetic symbols as claimed in claim 4, wherein said complete pronunciation data built in said word bank unit are composed of many Chinese phonetic symbols arranged from the left to the right.

6. A language teaching system of orientation phonetic symbols as claimed in claim 4, wherein said electronic computer is further provided with a sound output device for outputting sounds, said pronunciation teaching module also comprising a sound data bank unit and an immediate pronunciation auxiliary unit, said sound data bank unit built therein with sound data with correct pronunciation for said English letters that are respectively marked with pronunciation auxiliary marks, and sound data with correct pronunciation for said English phonetic symbol words, said immediate pronunciation auxiliary unit able to collate and select sound data of said English phonetic symbol words or said English letters from said sound data bank unit and output said sound data through said sound output device when said cursor is pinpointed to select an English phonetic symbol word or one English letter of an English phonetic symbol word.

7. A language teaching system of orientation phonetic symbols as claimed in claim 1, wherein there are three kinds of pronunciation auxiliary marks to be marked on English letters of English phonetic symbol words built in said word bank unit, a dot mark representing a short sound, a dash mark representing a long sound and a slanting stroke representing an accent pronounced with force.

8. A language teaching system of orientation phonetic symbols as claimed in claim 2, wherein the sound symbols in said vowel orientation phonetic symbol table are composed of Chinese phonetic symbols and K.K. phonetic symbols, which are similar or the same in pronunciation.

9. A language teaching system of orientation phonetic symbols as claimed in claim 3, wherein the sound symbols in said consonant orientation phonetic symbol table are composed of Chinese phonetic symbols and K.K. phonetic symbols, which are similar or the same in pronunciation.

10. A language teaching system of orientation phonetic symbols possible to be built in an electronic computer with a screen, said orientation phonetic symbols and language teaching system provided with a pronunciation teaching module, said pronunciation teaching module comprising:
a word bank unit built therein with many Chinese vocabulary data and many Chinese phonetic symbol words respectively corresponding with said Chinese vocabulary, arrangement of English letter of each said Chinese phonetic symbol word completely corresponding to the Chinese phonetic symbols of said Chinese vocabulary, comprising one English letter to several English letters arranged from the left to the right, the first English letter at the left side being a capital letter and a numeral located at a right side of the last English letter for standing for a Chinese intonation, a pronunciation auxiliary mark representing a sound of said English letter being marked at a specified orientation of the periphery of a Chinese phonetic symbol word, according to the sound of said English letter, said pronunciation auxiliary mark placed on said English letter, which serves as a vowel, of said Chinese phonetic symbol word correspondingly put at one of the following spots of said English letter: a central one, an exactly upper one, an exactly lower one, a left side one, a right side one, an upper left one, a lower left one, an upper right one and an upper lower one; and
a character input device, an identification-conversion unit collating and picking out Chinese phonetic symbol words of said Chinese vocabulary from said word bank unit so as to enable a user to select a word he needs and display it on a screen.

11. A language teaching system of orientation phonetic symbols as claimed in claim 10, wherein the phonetic symbol portion of Chinese phonetic symbol words built in said word bank unit consists of several English letters arranged from the left to the right and a numeral arranged at the right side of said English letter, and a pronunciation auxiliary mark representing the sound of said English letter is marked at a predetermined position of one English letter.

12. A language teaching system of orientation phonetic symbols as claimed in claim 11, wherein said pronunciation teaching module also comprises a phonetic symbol display unit able to display a vowel orientation phonetic symbol table on the screen, said vowel orientation phonetic symbol table formed with nine matrix-arranged orientation blocks respectively defined to show a specified vowel sound, each said orientation block displayed therein with a sound symbol standing for said vowel sound, in accordance with the vowel sound of said English letter, said pronunciation auxiliary mark marked on an English letter that severs as a vowel, in the phonetic symbol portion of said Chinese phonetic symbol word said pronunciation auxiliary mark being correspondingly placed at a central spot, at an exactly upper spot, at an exactly lower spot, at a left side spot, at a right side spot, at an upper left spot, at a lower left spot, at an upper right spot or at a lower right spot.

13. A language teaching system of orientation phonetic symbols as claimed in claim 12, wherein said phonetic symbol display unit can also display a consonant orientation phonetic symbol table on the screen, said consonant orientation phonetic symbol table formed with several matrix-arranged square blocks, said square blocks respectively showing at least one English letter used to serve as a consonant, or one English letter used to serve as a consonant and marked with a pronunciation auxiliary mark at a predetermined location, a sound symbol representing a consonant sound of said English letter marked at a location adjacent to said English letter.

14. A language teaching system of orientation phonetic symbols as claimed in claim 13, wherein said phonetic symbol display unit can also display a pronunciation intonation table on the screen, said pronunciation intonation table formed with several square blocks, each said square block marked therein with an intonation symbol representing a specified intonation, and a numeral corresponding with said intonation symbol.

15. A language teaching system of orientation phonetic symbols as claimed in claim 10, wherein said electronic computer is formed with a cursor able to move on the screen and be pinpointed to select English letters displayed on the screen, said word bank unit also built therein with lots of sound data respectively corresponding with a specified English letter marked with pronunciation auxiliary marks, said pronunciation teaching module also comprising an immediate reminding unit, said immediate reminding unit able to collate and select sound data of said English letter from said word bank unit and display an auxiliary viewing window with said sound data on the screen when said cursor pinpoints and picks out an English letter in the phonetic symbol portion of Chinese phonetic symbol words.

16. A language teaching system of orientation phonetic symbols as claimed in claim 15, wherein said electronic computer is further provided with a sound output device for outputting sounds, and said pronunciation teaching module further contains a sound data bank unit and an immediate pronunciation auxiliary unit, said sound data bank unit built therein with sound data with correct pronunciation of the English letter marked with pronunciation auxiliary marks, and sound data with correct pronunciation of the phonetic symbol portion of said Chinese phonetic symbol words, said immediate pronunciation auxiliary unit able to collate and select said phonetic portion or said sound data of said English letter from said sound data bank and outputting said sound data through said sound output device when said cursor pinpoints and picks out Chinese phonetic symbol words or one English letter from the phonetic symbol portion of Chinese phonetic symbol words.

17. A language teaching system of orientation phonetic symbols as claimed in claim 10, wherein there are three kinds of pronunciation auxiliary marks marked on English letters of the Chinese phonetic symbol words built in said word bank unit: a dot symbol representing a short sound, a dash symbol representing a long sound and a slanting stroke symbol representing an accent pronounced with force.

18. A language teaching system orientation phonetic symbols as claimed in claim 12, wherein said sound symbols in said vowel orientation phonetic symbol table are composed of Chinese phonetic symbols and K.K. phonetic symbols, which are similar or the same in pronunciation.

19. A language teaching system of orientation phonetic symbols as claimed in claim 13, wherein said sound symbols in said consonant orientation phonetic symbol table are composed of Chinese phonetic symbols and K.K. phonetic symbols, which are similar or the same in pronunciation.
